(19) United States
(12) Patent Application Publication
(10) Pub. No.: US 2026/0295858 A1
(43) Pub. Date: Oct. 1, 2026

(54) DOMESTIC DISHWASHER

(71) Applicant: BSH Hausgeräte GmbH, Munich (DE)

(72) Inventors: Manuel Jörg, Dillingen (DE); Daniel Miller, Dillingen (DE); Michael Rupp, Holzheim (DE)

(21) Appl. No.: 18/993,013

(22) PCT Filed: May 16, 2023
(86) PCT No.: PCT/EP2023/063192

§ 371 Date: Jan. 10, 2025

(30) Foreign Application Priority Data
Jul. 18, 2022 (DE) 10 2022 207 318.5

(51) Int. Cl. B25J 11/00; A47L 15/00; B25J 15/00; B25J 19/02

(52) U.S. Cl. CPC B25J 11/0085; A47L 15/0028; A47L 15/0049; B25J 15/0019; B25J 19/021; A47L 2401/04; A47L 2401/34; A47L 2501/22; A47L 2501/32; A47L 2501/36

(57) ABSTRACT

A household dishwasher includes a dishwasher cavity for receiving items to be washed, a household robot, and an open-loop and closed-loop control facility configured to execute a wash program for cleaning the items to be washed and to interrupt the wash program during execution of the wash program in order to enable the household robot to access the dishwasher cavity.

The present invention relates to a household dishwasher.

A dishwasher comprises a dishwasher cavity which can receive items to be washed for cleaning. When operating the dishwasher, it is possible that after a wash program has been run, soiling and/or water residues remain on some of the items to be washed. This may make it necessary to run the wash program again or to clean or dry the items manually.

DE 10 2020 204 083 A1 describes a computer program for a robot with a computer for operating a household dishwasher, having a plurality of treatment programs, comprising instructions which, when the computer program product is executed by the computer, cause the robot to perform the following steps: load dishwasher skills specific to the household dishwasher from a memory and execute at least some of the loaded dishwasher skills for operating the household dishwasher.

Based on this background, it is an object of the present invention to provide an improved household dishwasher.

Accordingly, a household dishwasher is proposed with a dishwasher cavity for receiving items to be washed, an open-loop and closed-loop control facility for executing a wash program for cleaning the items to be washed, and a household robot, wherein the open-loop and closed-loop control facility is configured to interrupt the wash program during the execution thereof in order to enable the household robot to access the dishwasher cavity.

By virtue of the fact that the wash program is interrupted and the household robot has access to the dishwasher cavity, it is possible to remove soiling and/or water residues from the items to be washed or individual objects thereof with the aid of the household robot.

The dishwasher cavity is preferably cube-shaped. It is possible to provide multiple receptacles for receiving the items to be washed in the dish washer cavity. It is preferred that a door is attached to the dishwasher cavity in such a manner that the door is able to pivot and can be opened to enable the household robot to access the dishwasher cavity. The open-loop and closed-loop control facility is configured so as to actuate the household dishwasher in order to perform the wash program. Multiple wash programs can be stored in the open-loop and closed-loop control facility. The open-loop and closed-loop control facility can also be configured so as to actuate the household robot or to actuate an open-loop and closed-loop control facility of the household robot. The open-loop and closed-loop control facility of the household robot can be part of the open-loop and closed-loop control facility of the household dishwasher or vice versa. The items to be washed can include any number of objects, such as, for example, glasses, plates, bowls, cups, cutlery or the like.

It is preferred that the household robot has a movable robotic arm. The household robot can be arranged in such a manner that the robotic arm protrudes into the dishwasher cavity in order, for example, to move or displace the items to be washed. The household robot can be positioned in or at the dishwasher cavity. For example, the household robot is fixedly connected to the dishwasher cavity. However, this is not absolutely necessary. The household robot can also be positioned next to the household dishwasher. The household robot can however also be mobile. For this purpose, the household robot can have a drive. It is thus possible for the household robot to independently change its position relative to the household dishwasher, in particular with the aid of the drive.

The expression that the wash program is “interrupted” means in the present case in particular that the wash program is terminated for example after a specific program step, the household robot accesses the dishwasher cavity and the wash program is then restarted. The wash program can include, for example, a pre-wash cycle, a cleaning cycle, an intermediate rinse cycle, a final rinse cycle and a drying cycle. For example, the household robot can access the dishwasher cavity prior to the drying cycle. The wash program can also be modified. This can mean, for example, that program steps are added, repeated or not performed.

In accordance with one embodiment, the household robot has a robotic arm with a sensor system, in particular a camera, and/or an effector.

The sensor system can comprise the camera. However, the sensor system can also comprise, for example, a Lidar system (light detection and ranging system). It is preferred that the robotic arm supports the sensor system and the effector. The effector can be, for example, a gripper, with which objects of the items to be washed can be gripped. The effector can be any component that is suitable for manipulating or moving individual objects of the items to be washed.

In accordance with a further embodiment, the open-loop and closed-loop control facility is configured so as to open a door of the dishwasher cavity to enable the household robot to access the dishwasher cavity.

It is preferred that the door is assigned a door opening mechanism. This door opening mechanism can be actuated by the open-loop and closed-loop control facility in order to open the door in an automated manner as soon as the wash program is interrupted so that the household robot can access the dishwasher cavity through the open door. It is possible to forego opening the door manually.

In accordance with a further embodiment, the household robot is positioned inside or outside the dishwasher cavity.

The household robot can be attached to the dishwasher cavity on the inside. However, the household robot can also be arranged next to the dishwasher cavity, for example. The household robot can be fixedly connected to the dishwasher cavity. However, this is not absolutely necessary. In the event that the household robot is arranged within the dishwasher cavity, this is in particular encapsulated in a watertight manner.

In accordance with a further embodiment, the household robot is configured so as to localize individual objects of the items to be washed.

“Localize” in the present context is to be understood to mean that the household robot is configured so as to detect a respective position of the objects in the dishwasher cavity. The objects can include glasses, plates, cups, pots, cutlery or the like.

In accordance with a further embodiment, the household robot is configured so as to change a position of the objects.

For example, the household robot can rotate or re-position specific objects so that water residues run off the respective object, for example. “Position” of a respective object is to be understood in the present case to mean its position or orientation within the dishwasher cavity.

In accordance with a further embodiment, the household robot is configured so as to classify the objects in terms of their type, in terms of soiling and/or in terms of water residues.

“Type” is understood to mean in the present case different objects, such as for example plates, bowls, cups, glasses, cutlery or the like. For example, classification can be performed on the basis that cutlery is less susceptible to water residues than hollow items such as, for example, bowls. “Classification” in the present case is to be understood to mean that the household robot is configured so as to detect and assess different objects on the basis of their shape, soiling and/or water residues.

In accordance with a further embodiment, in order to remove the soiling and/or the water residues, the household robot has a mechanical element, a laser facility, a compressed air nozzle, a water nozzle, a water suction facility and/or a heating element.

Soiling can be removed from the respective object with the aid of mechanical elements, the laser facility, the compressed air nozzle and the water nozzle. However, water residues can be removed with the aid of the compressed air nozzle, the water suction facility or the heating element.

In accordance with a further embodiment, the household robot is configured so as to displace and/or rotate the objects to facilitate the removal of water residues.

For example, it is possible for the household robot with the aid of its effector to grip an object that has, for example, soiling and/or water residues. The household robot can then displace and/or rotate this object within the dishwasher cavity so that the water residues can run off from the respective object.

In accordance with a further embodiment, in order to remove water residues, the household robot is configured so as to displace and/or raise a receptacle for receiving items to be washed that is receiving the objects.

In this case, it is not individual objects that are displaced and/or raised with the aid of the household robot but the entire receptacle for items to be washed. For example, the household robot uses its effector to grip the respective receptacle for items to be washed.

In accordance with a further embodiment, the receptacle for items to be washed is divided into multiple zones, wherein the zones differ from one another by virtue of the fact that different zones can receive objects that have a different potential for water residues.

In this case, it is advantageously possible to forego a camera since the objects are directly sorted into the different zones. “Potential” for water residues is to be understood in the present case to mean that different objects of the items to be washed can take up different amounts of water. Thus, a knife has considerably less potential for water residues than a glass, for example.

In accordance with a further embodiment, the household robot is configured so as to place additional objects into the dishwasher cavity after an interruption of the wash program.

For example, this can be necessary if the additional objects were still being used at the time of the original start of the wash program. It is also still possible to place objects which have been forgotten into the dishwasher cavity.

In accordance with a further embodiment, the open-loop and closed-loop control facility is configured so as to adapt the wash program in dependence upon the objects that have been added.

For example, a further cleaning cycle and/or an intermediate rinse cycle can be added to the wash program.

In accordance with a further embodiment, the household robot is configured so as to detect and eliminate a fault occurring within the dishwasher cavity.

For example, a spray arm that is rotatably mounted within the dishwasher cavity can be blocked by an object of the items to be washed. It is possible for the household robot with the aid of its sensor system to detect this blockage or receive a signal regarding the blockage of the household dishwasher and identify and subsequently remove or re-position the offending object so that the spray arm is no longer blocked.

In accordance with a further embodiment, the open-loop and closed-loop control facility is configured so as to adapt the wash program to a presence of people in the vicinity of the household dishwasher.

For example, the wash program can be adapted in such a manner that the household dishwasher emits less noise.

Advantageously, the household dishwasher is always in communication with the household robot or external sensors. This communication can take place in numerous ways, such as for example via electrical signals, optical signals, electromagnetic waves, sound or the like. The OSI (open systems interconnection) model is considered as a reference model. The communication can be based on individual or all layers of the OSI model and transmit data continuously or only at a specific time. In addition, it is possible for the household robot to communicate with the household dishwasher in the ways explained below. Locally, this can be done via direct communication between the household robot and the household dishwasher or indirect communication between the household robot and the household dishwasher, in particular from the household dishwasher to the robot controller or from the robot controller to the household robot.

In the cloud-based system, this can be done by indirect communication between the household robot and the household dishwasher, in particular from the household dishwasher to the cloud of the robot provider or from the cloud of the robot provider to the household robot, indirect communication between the household robot and the household dishwasher, in particular from the household dishwasher to the cloud of the household dishwasher or from the cloud of the household dishwasher to household robot, or indirect communication between the household robot and the household dishwasher, in particular from the household dishwasher to the cloud of the household dishwasher, from the cloud of the household dishwasher to the cloud of the robot provider or from the cloud of the robot provider to household robot.

In the case of cloud-based communication, it is also possible for this connection to be transmitted via a mobile radio unit, in particular from the household robot, from the household dishwasher or from both the household robot and the household dishwasher.

In addition, it is possible for the data processing to take place either locally at the household robot, a robot control unit, a further external control unit or alternatively in the cloud.

The data to be transmitted may include, for example, sensor data, in particular from internal sensors of the household dishwasher or the household robot, such as current values, motor rotational speeds, camera images or the like, states or fault states of the household dishwasher and/or the household robot, parameters of individual components of the household dishwasher and/or the household robot, a progress of the washing process, information about the washing process or data that is necessary for the household robot or the household dishwasher to perform one of the described applications. The data may include position data, in particular of dishware items, a maximum force of the effector of the household robot, a maximum speed of the household robot, sensor data or the like.

In principle, it is also possible for the communication to originate from the household robot. One example is communication between the household robot and the household dishwasher due to a request or the required sensor data from the household dishwasher for the execution of one of the mentioned applications.

Further possible implementations of the household dishwasher also comprise combinations, not explicitly mentioned, of features or embodiments which are described above or below with regard to the exemplary embodiments. In this case, the person skilled in the art will also add individual aspects as improvements or supplements to the respective basic form of the household dishwasher.

Further advantageous embodiments and aspects of the household dishwasher are the subject of the subordinate claims and the exemplary embodiments of the household dishwasher that are described below. Furthermore, the household dishwasher is described in detail with the aid of preferred embodiments with reference to the attached figures.

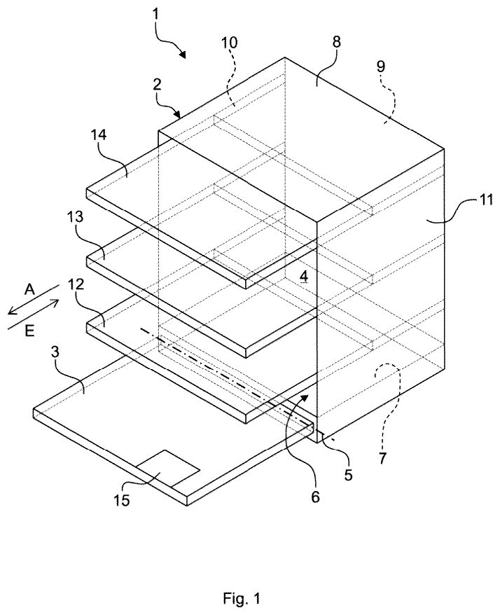

FIG. 1 shows a schematic perspective view of an embodiment of a household dishwasher;

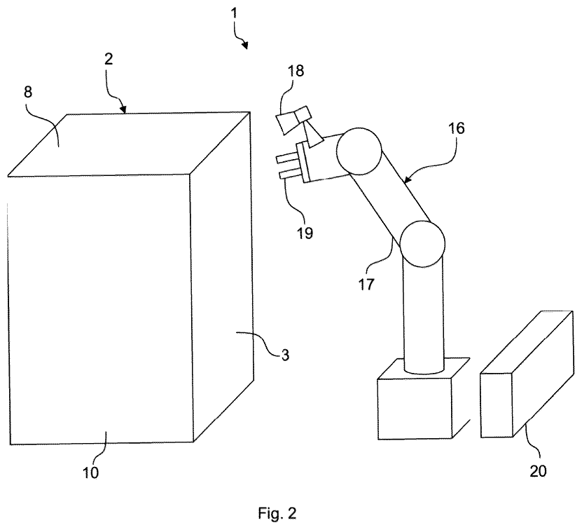

FIG. 2 shows a further schematic perspective view of the household dishwasher;

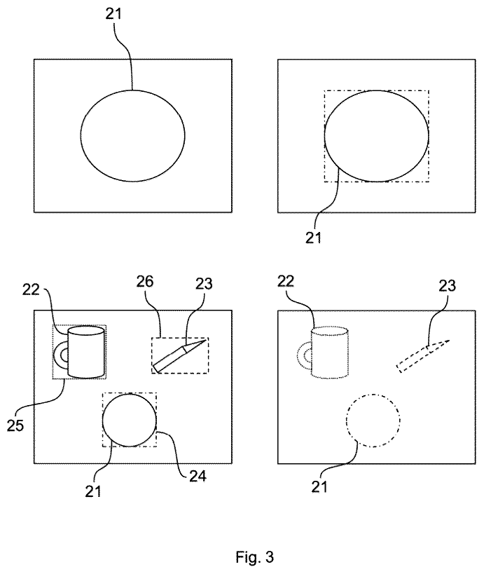

FIG. 3 shows different schematic views of objects that can be received in the household dishwasher;

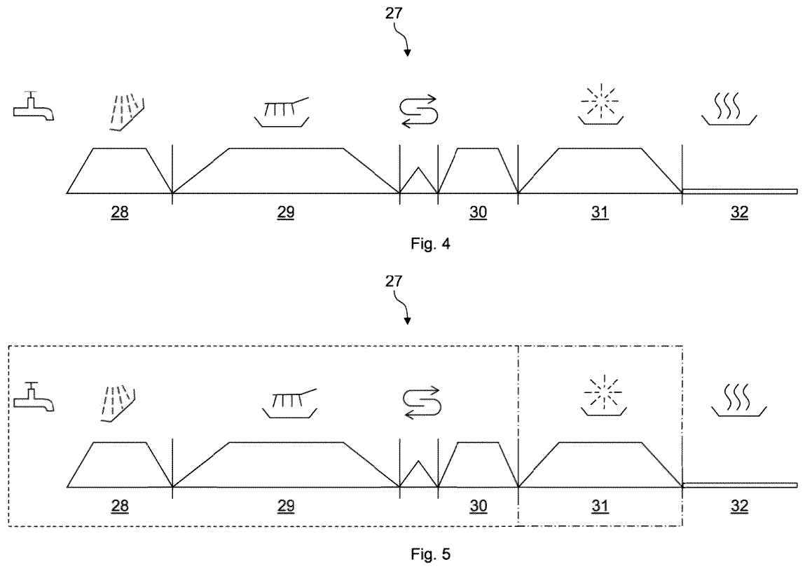

FIG. 4 shows a schematic view of a wash program for the household dishwasher in accordance with FIG. 1;

FIG. 5 shows a further schematic view of the wash program in accordance with FIG. 4;

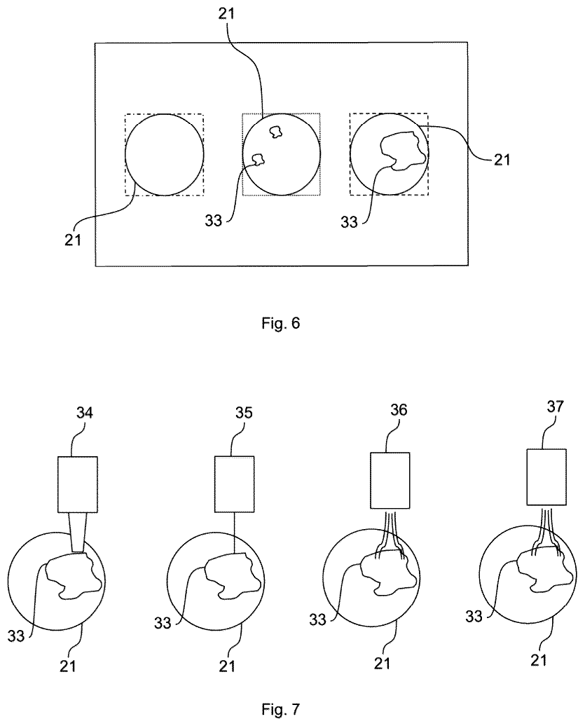

FIG. 6 shows a schematic view of an object that can be received in the household dishwasher;

FIG. 7 shows a view of different embodiments of tools which can be attached to a robotic arm;

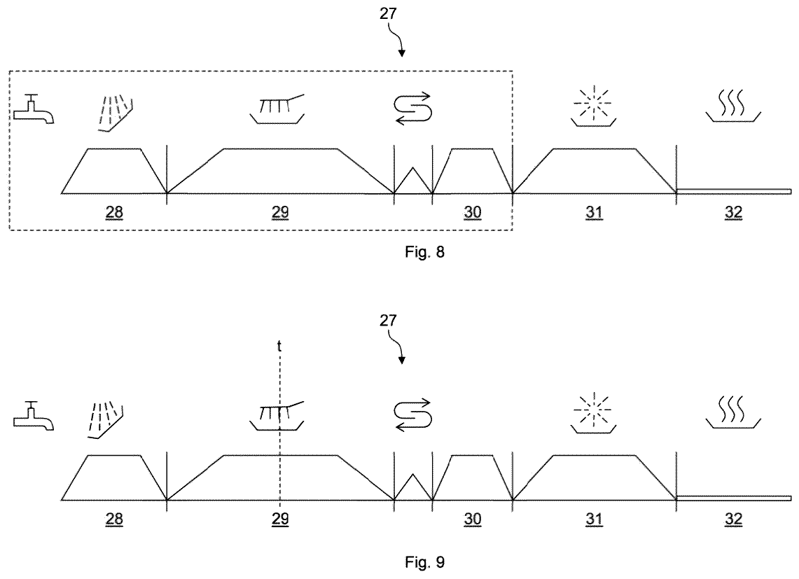

FIG. 8 shows a further schematic view of the wash program in accordance with FIG. 4;

FIG. 9 shows a further schematic view of the wash program in accordance with FIG. 4;

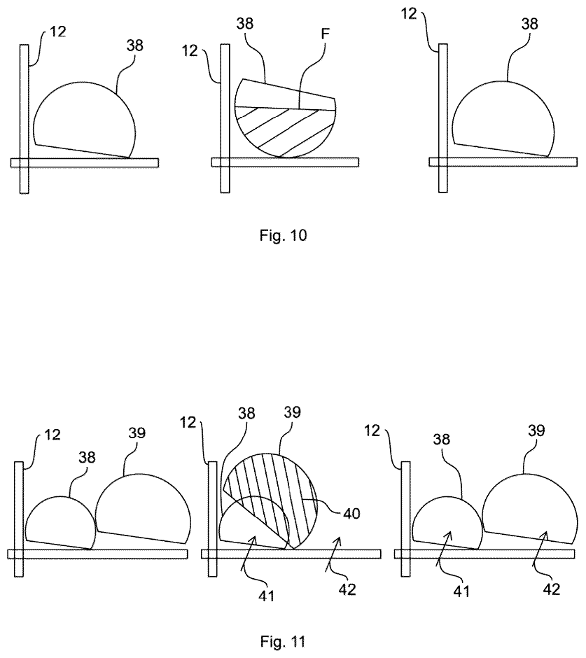

FIG. 10 shows multiple schematic views of a receptacle for items to be washed for the household dishwasher in accordance with FIG. 1;

FIG. 11 shows further schematic views of the receptacle for items to be washed in accordance with FIG. 10;

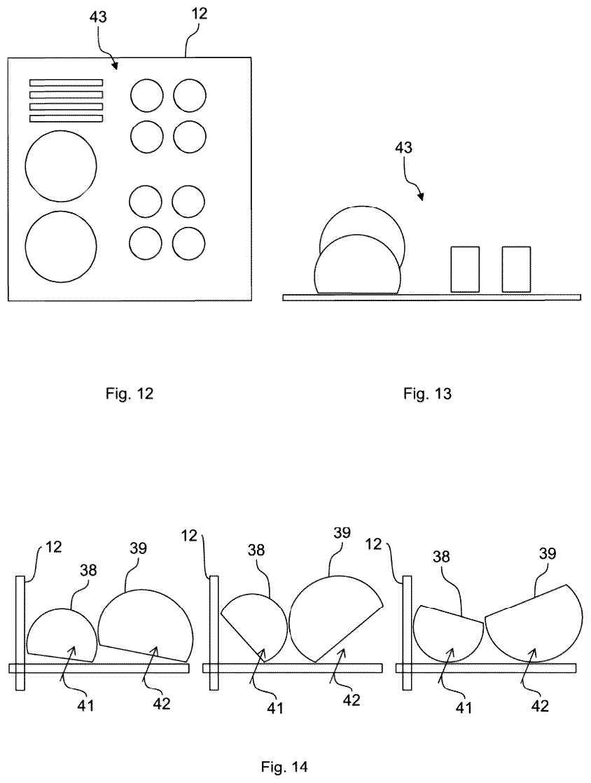

FIG. 12 shows a schematic view of the receptacle for items to be washed in accordance with FIG. 10;

FIG. 13 shows a schematic side view of the receptacle for items to be washed in accordance with FIG. 10;

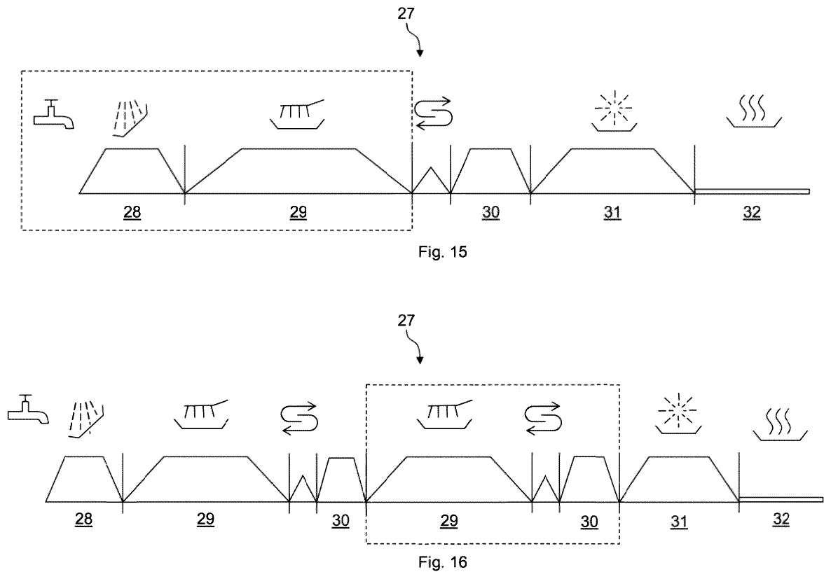

FIG. 14 shows further schematic views of the receptacle for items to be washed in accordance with FIG. 10;

FIG. 15 shows a further schematic view of the wash program in accordance with FIG. 4;

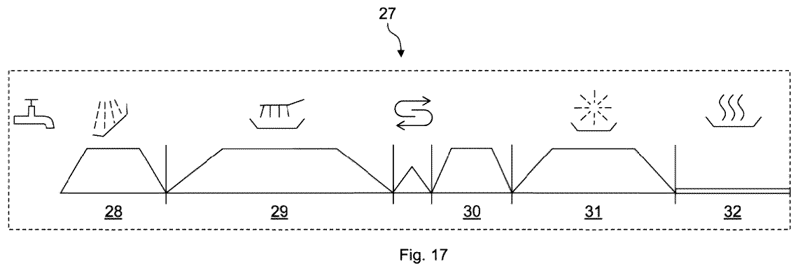

FIG. 16 shows a further schematic view of the wash program in accordance with FIG. 4;

FIG. 17 shows a further schematic view of the wash program in accordance with FIG. 4;

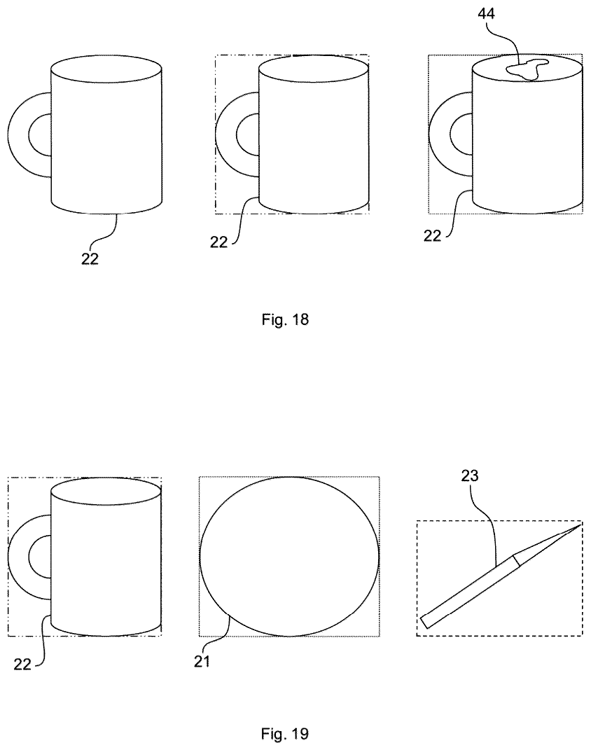

FIG. 18 shows multiple schematic views of an object that can be received in the household dishwasher;

FIG. 19 shows a schematic view of different objects that can be received in the household dishwasher;

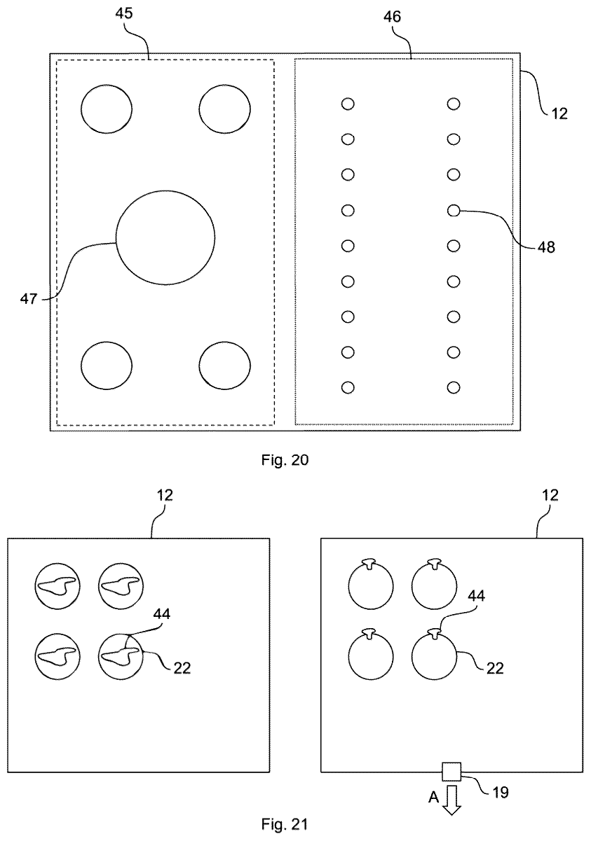

FIG. 20 shows a further schematic view of the receptacle for items to be washed in accordance with FIG. 10;

FIG. 21 shows further schematic views of the receptacle for items to be washed in accordance with FIG. 10;

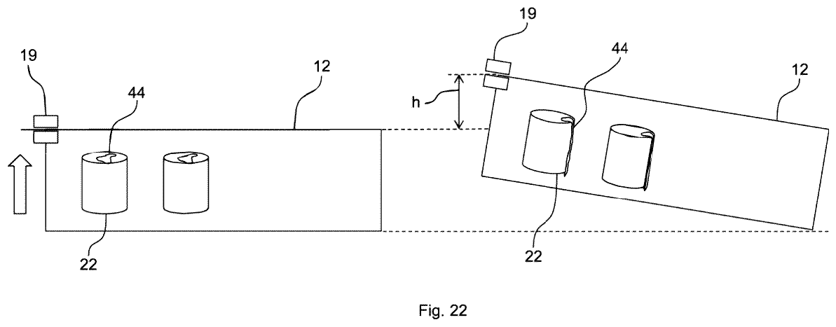

FIG. 22 shows further schematic side views of the receptacle for items to be washed in accordance with FIG. 10;

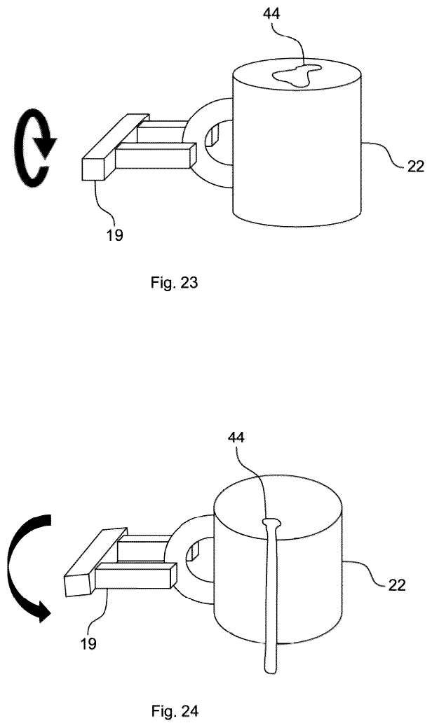

FIG. 23 shows a schematic perspective view of an object that can be received in the household dishwasher;

FIG. 24 shows a further schematic perspective view of the object in accordance with FIG. 23;

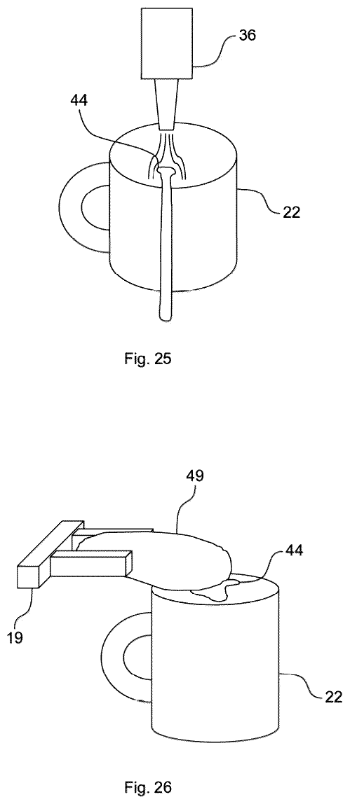

FIG. 25 shows a further schematic perspective view of the object in accordance with FIG. 23;

FIG. 26 shows a further schematic perspective view of the object in accordance with FIG. 23;

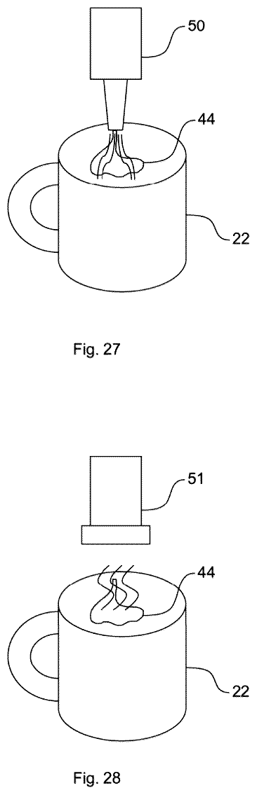

FIG. 27 shows a further schematic perspective view of the object in accordance with FIG. 23;

FIG. 28 shows a further schematic perspective view of the object in accordance with FIG. 23;

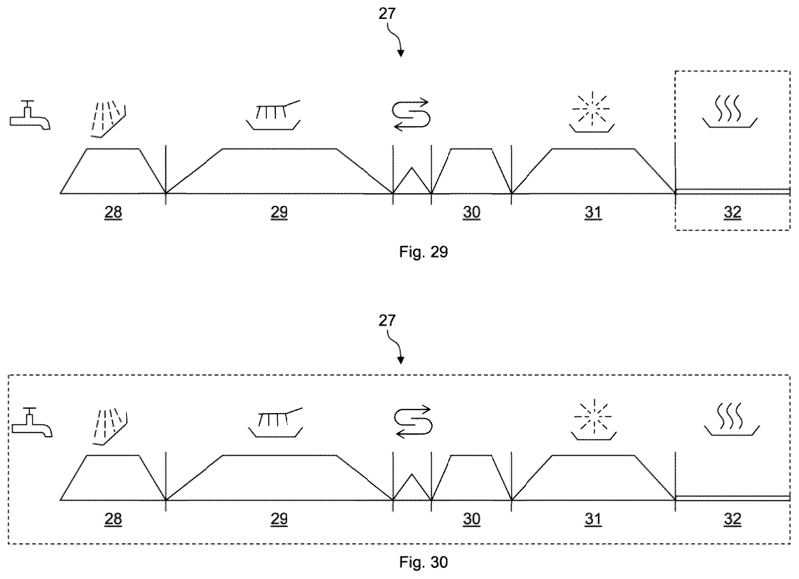

FIG. 29 shows a further schematic view of the wash program in accordance with FIG. 4;

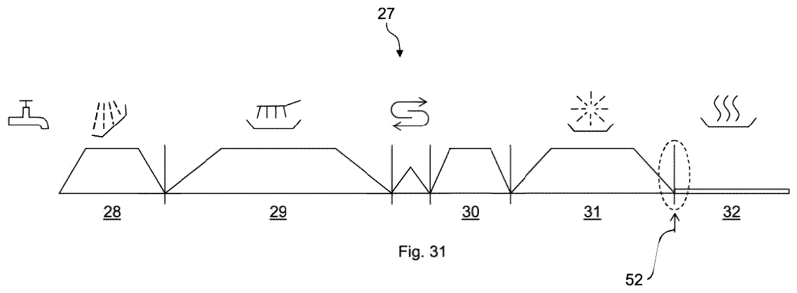

FIG. 30 shows a further schematic view of the wash program in accordance with FIG. 4;

FIG. 31 shows a further schematic view of the wash program in accordance with FIG. 4;

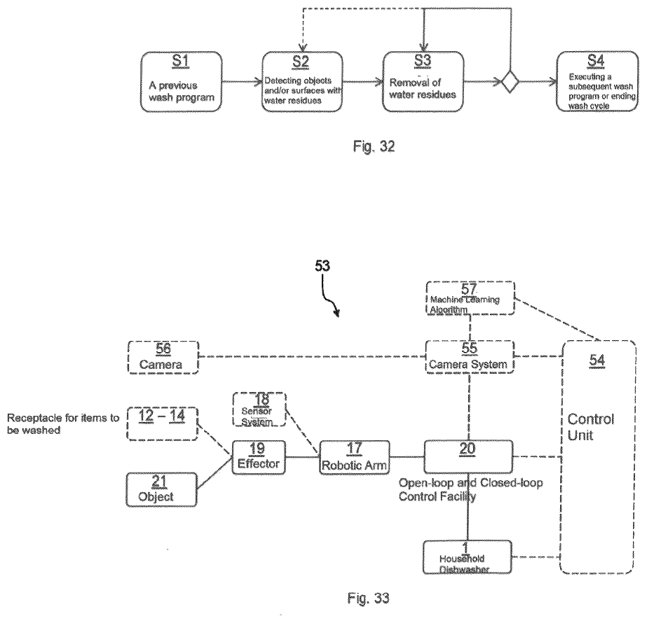

FIG. 32 shows a schematic block diagram of a method for operating the household dishwasher in accordance with FIG. 1; and

FIG. 33 shows a schematic view of the system that has the household dishwasher in accordance with FIG. 1.

Identical or identically functioning elements are provided in the figures with the same reference characters unless not otherwise indicated.

FIG. 1 shows a schematic perspective view of an embodiment of a household dishwasher 1. The household dishwasher 1 comprises a dishwasher cavity 2 which can be sealed, in particular in a water-tight manner, by a door 3. For this purpose, a sealing facility can be provided between the door 3 and the dishwasher cavity 2. The dishwasher cavity 2 is preferably cube-shaped. The dishwasher cavity 2 can be arranged in a housing of the household dishwasher 1. The dishwasher cavity 2 and the door 3 can form a dishwasher interior 4 for washing items to be washed.

The door 3 is illustrated in FIG. 1 in its open position. The door 3 can be closed or opened by pivoting about a pivot axis 5 that is provided at a lower end of the door 3. A loading opening 6 of the dishwasher cavity 2 can be closed or opened with the aid of the door 3. The dishwasher cavity 2 has a base 7, a top 8 that is arranged opposite the base 7, a rear wall 9 that is arranged opposite the closed door 3 and two side walls 10, 11 that are arranged opposite each other. The base 7, the top 8, the rear wall 9 and the side walls 10, 11 can be produced, for example, from a stainless steel sheet. Alternatively, by way of example, the base can be produced from a plastic material.

Moreover, the household dishwasher 1 has a receptacle 12 to 14 for items to be washed. It is preferred that multiple, for example three, receptacles 12 to 14 for items to be washed can be provided, wherein the receptacle 12 for items to be washed can be a lower receptacle for items to be washed or a lower basket, the receptacle 13 for items to be washed can be an upper receptacle for items to be washed or an upper basket and the receptacle 14 for items to be washed can be a cutlery drawer.

Furthermore, as shown in FIG. 1, the receptacles 12 to 14 for items to be washed are arranged one above the other in the dishwasher cavity 2. Each receptacle 12 to 14 for items to be washed can be displaced into or out of the dishwasher cavity 2 as desired. In particular, each receptacle 12 to 14 for items to be washed can be pushed or moved into the dishwasher cavity 2 in an insertion direction E or pulled out or moved out of the dishwasher cavity 2 in a pull-out direction A opposite the insertion direction E.

The household dishwasher 1 comprises an open-loop and closed-loop control facility 15. The household dishwasher 1 can be actuated with the aid of the open-loop and closed-loop control facility 15. For example, different wash programs can be executed with the aid of the open-loop and closed-loop control facility 15. The open-loop and closed-loop control facility 15 can be positioned within the door 3.

FIG. 2 shows a further schematic perspective view of the household dishwasher 1. The household dishwasher 1 has a household robot 16. The household robot 16 can be positioned inside or outside the dishwasher cavity 2. The household robot 16 can be mounted on the dishwasher cavity 2. Alternatively, the household robot 16 can also be arranged—as shown in FIG. 2—n ext to the dishwasher cavity 2. In this case, the household robot 16 is not directly connected to the dishwasher cavity.

The household robot 16 comprises a movable robotic arm 17, a sensor system 18, in particular a camera system, which is attached to the robotic arm 17, and an effector 19 which can be designed as a gripper. Moreover, an open-loop and closed-loop control facility 20 is assigned to the household robot 16. The open-loop and closed-loop control facility 20 can communicate with the open-loop and closed-loop control facility 15. Moreover, the open-loop and closed-loop control facility 20 can also be part of the open-loop and closed-loop control facility 15 or vice versa.

It is possible to improve the drying performance of the household dishwasher 1 with the aid of the household robot 16, for example. For this purpose, water residues that are located in parts of items to be washed or in the receptacle 12 to 14 for items to be washed after a rinse cycle or wash cycle can be removed with the aid of the household robot 16. The household robot 16 can be located inside or outside the household dishwasher 1.

There are various conceivable applications in which the household robot 16 can intervene during a wash program. For example, an intervention can be made in the cleaning process itself. This can be carried out with the aid of a corresponding dosage of detergent and/or rinsing agent, a cleaning support or a program change. Alternatively or additionally, it is also possible to intervene in the positioning of objects, in particular items to be washed. In this case, it is possible to correct positions of object, to add an object or remove an object.

Alternatively or additionally, intervening in the drying process can be carried out by way of detecting and removing water residues. Furthermore, automatic fault handling is possible in that fault cases are detected and rectified.

In some of the above-mentioned applications, it is necessary that the position of the objects is assumed to be known. Since this can only be achieved to a limited extent when items are loaded by a user or with exact positioning by the household robot 16, the sensor system 18 is considered optional for these applications. The methodology explained below can be used for multiple applications.

FIG. 3 shows multiple objects 21 to 23 which are to be localized and/or classified. The objects 21 to 23 are items to be washed. For example, the object 21 is a plate (dashed-dotted), the object 22 is a cup (dotted) and the object 23 is a knife (dashed). In order for the objects 21 to 23 to be classified and localized, it is necessary to evaluate camera images. This can be implemented, for example, using artificial intelligence, with the aid of a convolutional neural network, for example.

Various methods for detection, localization and segmentation are shown in FIG. 3. It is conceivable to classify, to classify and simultaneously localize the objects 21 to 23 in images, to differentiate multiple objects in an image using bounding boxes 24 to 26, and also to detect the objects 21 to 23 in the image on a pixel basis. It is likewise conceivable to classify the objects 21 to 23 not only on the basis of their appearance but also on the basis of other characteristics, such as for example their degree of soiling or whether the contours of the respective object 21 to 23 make it susceptible to residual water remaining after the wash program.

It is possible on the basis of information regarding a localized object 21 to 23 to determine the orientation of the respective object 21 to 23 in the interior. Optionally, the orientation of object 21 to 23 in the interior can be determined with the aid of further information or a sensor signal, for example with the aid of a 3D camera or a Lidar system (light detection and ranging), and assigned to the object 21 to 23 that has already been localized. The determination of orientation in the interior can also be implemented using artificial intelligence, for example with the aid of a convolutional neural network. Orientation can be described, for example, by translation and rotation to a reference point or coordinate system.

FIGS. 4 and 5 each represent an exemplary wash program 27 of the household dishwasher 1. The wash program 27 comprises a pre-wash cycle 28, a cleaning cycle 29, an intermediate rinse cycle 30, a final rinse cycle 31 and a drying cycle 32. Fundamentally the household robot 16 is able to intervene in the active wash program 27 at any point in time.

Multiple applications are possible. For example, detergent and/or rinsing agent can be metered. It is possible to add detergents and rinsing agents during the wash program 27 adaptively and consequently adapted to the current level of soiling of the items to be washed. This can take place depending on the phase of the wash program 27, depending on the sensor data or when, for example, food residues that have not been removed are detected by the sensor system 18 in combination with a classification algorithm (example classes: very heavily soiled items to be washed, heavily soiled items to be washed, soiled items to be washed, clean items to be washed) of the household robot 16. FIG. 5 illustrates phases in which it is possible to add detergent (dashed box) or rinsing agent (dash-dotted box).

Another application is cleaning support. For this purpose, the cleaning of the items to be washed can be supported with the help of the household robot 16 during the wash program 27. This can be done, for example, by the household robot 16 exerting a supporting mechanical force. The items to be washed are detected in the same way as in the generally described methodology for detecting objects 21 to 23. In addition, a further algorithm can be used to classify items to be washed on the basis of their soiling.

An example of this is shown in FIG. 6, where items are classified into clean items to be washed or objects 21 (dashed-dotted box), soiled objects 21 (dotted box) and very heavily soiled objects 21 (dashed box). In the case of the heavily soiled objects 21, it can be assumed that a very long cleaning duration by way of the household dishwasher 1 is necessary to remove the soiling 33 or that the soiling 33 cannot be removed by the household dishwasher 1 alone. In order to prevent this, the dirt can also be removed roughly or completely with the household robot 16.

FIG. 7 shows soiled items to be washed. A soiling 33 adheres to an object 21 as previously explained, in particular a plate. The removal of the heavy soiling 33 can take place, among other things, by a mechanical, electromechanical, pneumatic or hydraulic external action. For this purpose, a mechanical element 34, a laser facility 35, a compressed air nozzle 36 or a water nozzle 37 can be attached to the robotic arm 17 to remove the soiling.

FIG. 8 illustrates the wash program 27 again. In FIG. 8, possible phases in which cleaning support can take place by way of the household robot 16 are enclosed in a box.

Accordingly, the cleaning support can be carried out during the pre-wash cycle 28, the cleaning cycle 29 and/or the intermediate rinse cycle 30.

According to a further application, it is possible to adapt the wash program 27 to the changed situation during the wash program 27 due to changing environmental conditions. An example can be the detection of people in the vicinity of the household dishwasher 1. This can take place, for example, with the generally described methodology for detecting objects 21 to 23 or with additional external sensor data, for example from the integrated sensor system 18 of the household robot 16.

If people are detected, the wash program 27 can be adapted to this new situation and switch to an extra quiet mode in order to emit as little noise as possible into the environment. Another example is the adaptation of the wash program 27 when a larger group of people are present. It can be deduced that a larger number of items to be washed must be available in a short time and that the household dishwasher 1 should complete the wash program extra quickly.

It is possible to change or adapt the program throughout the entire wash program 27. An example can be seen in FIG. 9. The wash program 27, for example, is started with the program selection Eco 50° at the beginning and is extended at a point in time t with the additional selection ‘Quiet’ due to one or more detected people in the vicinity of the household dishwasher 1. This additional selection can influence significant parameters, such as, for example, a reduced pump rotational speed, in order to reduce the noise level emitted by the household dishwasher 1. At the same time, it is possible to remove a possible additional option, such as, for example, ‘quiet’, when people are absent, in order to achieve improved and/or faster cleaning.

FIG. 10 shows schematic views of the receptacle 12 for items to be washed, in which an object 38 in the form of a bowl is received. The left-hand partial figure of FIG. 10 shows the object 38 before a start of the wash program 27. The center partial figure of FIG. 10 shows the object 38 during the wash program 27 and the right-hand partial figure of FIG. 10 shows the object 38 after a correction by the household robot 16.

It is possible to interrupt the wash program 27 and to carry out a correction of object positions. This correction of object positions can be carried out so that the items to be washed can be optimally cleaned and/or dried. The point in time of the correction can be specified or selected adaptively. For this purpose, the generally described methodology for detecting objects 38, including an orientation detection, can be used. On the basis of the orientation data, it can be evaluated whether the current position of the object 38 has a positive or negative effect on the washing process or alternatively, it can already be detected by object detection and classification whether, for example, the washing liquor and/or fresh water F or detergent is located in the object 38 and thus improved drying can be achieved by correcting the object position.

If the object 38 has turned over during the wash program 27 due to the hydraulic force (middle partial figure of FIG. 10), it is possible to detect this and correct it with the aid of the household robot 16 (right-hand partial figure of FIG. 10). This can prevent the object 38 from filling up with the washing liquor and/or fresh water F, or, in the case of an object 38 that is already full of washing liquor and/or fresh water F, it can be emptied again.

FIG. 11 shows further schematic views of the receptacle 12 for items to be washed, in which two objects 38, 39 in the form of bowls are held. The left-hand partial figure of FIG. 11 shows the objects 38, 39 before the start of the wash program 27. The middle partial figure of FIG. 11 shows the objects 38, 39 during the wash program 27 and the right-hand partial figure of FIG. 11 shows the objects 38, 39 after a correction by the household robot 16.

Due to unfavorable positioning, for example by the user, or due to the objects 38, 39 being moved or slipping during the washing process, the objects 38, 39 can cover each other (middle partial figure of FIG. 11), making cleaning more difficult. The fact that object 38 partially covers object 39 results in a so-called spray shadow 40, which is shown hatched in the middle partial figure of FIG. 11. The object 38 at least partially covers spray jets 41, 42 directed at objects 38, 39, so that these only partially reach the object 39.

As shown in FIGS. 12 and 13, the position correction can be carried out, for example, by way of a comparison with a standard pattern 43 for loading the household dishwasher 1 or with an optimization algorithm, the aim of which is to place each item to be washed in an optimal manner in the household dishwasher 1, so that each item to be washed is optimally cleaned and dried, as shown in FIG. 14. This can also be done with the aid of a learning algorithm. The left-hand partial figure of FIG. 14 shows an optimal placement of objects 38, 39, and the middle and right-hand partial figures of FIG. 14 show a non-optimal placement of objects 38, 39. FIG. 14 thus shows the result of an optimization algorithm for the optimal placement of objects 38, 39 (left-hand partial figure of FIG. 14) and a non-optimal placement of objects 38, 39 (middle and right-hand partial figure of FIG. 14).

It is also possible to intervene during the active wash program 27 and add the most varied objects 21 to 23, 38, 39. An example of this might be that the user was still using items to be washed at the start of the wash program 27 and these could not therefore be placed in the household dishwasher 1 at that time. With the aid of the household robot 16, it is possible during the active wash program 27, in the case of a freely available area in the respective receptacle 12 to 14 for items to be washed, to open the door 3 to add items to be washed and then to close the door 3 again.

If there is no longer any free space in the respective receptacle 12 to 14 for items to be washed, it is also possible to use an optimization algorithm to reposition the items to be washed that are already loaded in order to allow the additional items to be washed to be loaded. For this purpose, the previously described general methodology for detecting objects 21 to 23, 38, 39, including orientation detection, can be used. A conceivable period of time for intervention in the active wash program 27 is outlined in a small box in FIG. 15.

Accordingly, intervention is possible during the pre-wash cycle 28 and during the cleaning cycle 29.

In addition, it is possible to adapt the wash program 27 to this situation when the objects are no longer supplied. An example of this is illustrated in FIG. 16. According to FIG. 16, an item to be washed is added after the start of the wash program 27 during the intermediate rinse cycle 30 and a second cleaning cycle 29 is added to the wash program 27 in order to also optimally clean this added item to be washed.

As shown in FIG. 17, another approach to actively intervene in the wash program 27 is to remove objects 21 to 23, 38, 39 from the dishwasher interior 4. In the event that the household robot 16 has automatically loaded the items to be washed, it is possible to draw conclusions about the current load. If the loading process was carried out manually, it is possible to deduce the items to be washed that are present, including the orientation detection, with the aid of the generally described methodology for detecting objects 21 to 23, 38, 39, even after the start of the wash program 27. The active wash program 27 is only briefly interrupted for this action and then continued.

The automatic object removal by way of the household robot 16 can, for example, be triggered by the user because the user needs a specific object 21 to 23, 38, 39 at a specific time and this is located in the household dishwasher 1. In this case, the door 3 is opened by the household robot 16, the selected object 21 to 23, 38, 39 is removed and then the door 3 is closed again.

Another application is to deliberately remove individual objects 21 to 23, 38, 39 during the wash program 27 based on the object properties. Reasons for this may be, for example, temperature limits which, if exceeded, may result, for example, in unwanted irreversible deformation of the objects 21 to 23, 38, 39. As an example, a plastic lid of a resealable box can be mentioned, which has irreversibly deformed due to a temperature that is too high and thus no longer fits the box in the manner of a positive fit. This could be removed by the household robot 16 before a defined temperature range is exceeded, thus preventing deformation. It is conceivable that an object could be removed at any point during the wash program 27, as indicated in FIG. 17 with the aid of a small box surrounding the wash program 27.

Moreover, it is also possible, as illustrated in FIG. 18, to detect and to eliminate water residues 44 on an object, 22, for example a cup. This process is divided into two steps. On the one hand, detecting water residues 44 and on the other hand, removing the water residues 44. Three methods are possible for detecting the water residues 44 in order to detect objects 22 or items in the receptacle 12 to 14 for items to be washed which have water residues 44 or are susceptible to water residues 44.

Firstly, it is possible with the aid of the generally described methods for detecting objects 21 to 23, 38, 39 in an image to classify between items and/or surfaces without water residues (double dashed-dotted box in the central partial figure of FIG. 18) and items and/or surfaces with water residues 44 (dotted box in the right-hand partial figure of FIG. 18). It is intended to process the objects 21 to 23, 38, 39 defined with “water residue” using the household robot 16 in such a manner that the water residue 44 is removed to a great extent or is removed completely.

Secondly, it is possible with the aid of the algorithm of the generally described methodology for detecting objects 21 to 23 in an image to classify different items, such as for example cups, cutlery, plates or the like, as is illustrated in FIG. 19. FIG. 19 shows the result of a classification algorithm for classification of different objects 21 to 23. A cup, a plate and a knife are illustrated in FIG. 19. The result of this classification algorithm can be used in order to further divide these classified objects 21 to 23 with the aid of a further methodology.

It is possible, for example, to divide the objects into two further classes, namely objects 21 to 23 which have a high potential for water residues 44, such as for example cups, bowls, glasses, spoons or the like, and objects 21 to 23 which have a low potential for water residues 44, such as for example plates, knives, forks or the like. This subdivision can be defined for the first time by a series of experimental measurements, simulations or a machine learning algorithm, and can be further optimized and improved in the future. It is now possible to use the household robot 16 to process the objects 21 to 23 with a high potential for water residues 44 in such a way that the water residues 44 are removed.

Thirdly, it is possible to carry out a simplified method in which the sensor system 18 in the form of a camera can be optionally dispensed with. The prerequisite for this is that each object 21 to 23, 38, 39 has a defined position and orientation in the receptacle 12 to 14 for items to be washed. This can be implemented, for example, by a predetermined placement of the objects 21 to 23, 38, 39 with a holder. By dividing the respective receptacles 12 to 14 for items to be washed into different zones 45, 46, as shown in FIG. 20, it is possible, just as with the second approach mentioned above, by subdividing objects into two classes, namely objects 21 to 23, 38, 39 with a high potential for water residues 44 and objects 21 to 23, 38, 39 with a low potential for water residues 44, for the household robot 16 to only process the objects 21 to 23, 38, 39 with a high potential for water residues 44 in such a manner that the water residues 44 are removed.

A first zone 45 can have various holders 47 for various objects 21 to 23, 38, 39. A second zone 46 can be constructed in a classic style with hinged spikes 48, since the objects 21 to 23, 38, 39 received in the second zone 46 do not need to be processed by the household robot 16. The first zone 45 is suitable for objects 21 to 23, 38, 39 with a high potential for water residue 44. The second zone 46 is suitable for objects 21 to 23, 38, 39 with a low potential for water residues 44.

In a second step, as shown in FIG. 21, the water residues 44 are removed. Regardless of the procedure for detecting an object 21 to 23, 38, 39 with a high potential for water residues 44, there are the following procedures for processing these objects 21 to 23, 38, 39 separately in order to remove the water residues 44.

Firstly, a defined movement of the respective receptacle 12 to 14 for items to be washed can be carried out. With the aid of a defined movement of the respective receptacle 12 to 14 for items to be washed by the household robot 16, it is possible to remove the water residues 44. This can be done, for example, by a pulsed movement of the respective receptacle 12 to 14 for items to be washed. In this case, the effector 19 of the household robot 16 grips the receptacle 12 to 14 for items to be washed and moves it in such a way that the water residues 44 flow out of a problematic area, for example a cup bottom, as a result of the movement and are thus removed as illustrated in FIG. 21. In this case, the receptacle 12 to 14 for items to be washed is moved in the pull-out direction A and/or in the insertion direction E. The left-hand partial figure of FIG. 22 shows the respective receptacle 12 to 14 for items to be washed in a rest position and the right-hand partial figure of FIG. 21 during a movement by way of the household robot 16.

As shown in FIG. 22, a further possibility is to remove water residues 44 from the objects 21 to 23, 38, 39 with a defined movement of the respective receptacle 12 to 14 for items to be washed. To do this, the respective receptacle for items to be washed 12 to 14 is gripped at one point with the help of the household robot 16 and moved upwards by a height h. The left-hand partial figure of FIG. 22 shows the respective receptacle 12 to 14 for items to be washed in a rest position and the right-hand partial figure of FIG. 22 shows the receptacle 12 to 14 for items to be washed during an upward movement.

Alternatively, as shown in FIGS. 23 and 24, a defined movement of the respective object 21 to 23, 38, 39 can be carried out. The respective object 21 to 23, 38, 39 with a high potential for water residues 44 is gripped by the effector 19 and moved by a movement, such as a 360° rotation (FIG. . 23), for example, of the object 21 to 23, 38, 39 or a lateral tilting (FIG. 24) in order to move it into a position in which the water residues 44 can drain off.

Furthermore, an external influence can be used. The object 21 to 23, 38, 39 with a high potential for water residues 44 is processed with a further effector, such as, for example, a compressed air nozzle 36 (FIG. 25) as mentioned above, an absorbent material 49 (FIG. 26) in the form of a cloth, a water suction facility 50 (FIG. 27), a heating element 51 (FIG. 28), for example in the form of an infrared radiator or the like. The aforementioned components 36, 49, 50, 52 can be attached to the robotic arm 17 or gripped by the household robot 16 before processing.

In the case of the compressed air nozzle 36, the water residues 44 are blown off by a jet of air at an overpressure from the respective object 21 to 23, 38, 39 (FIG. 25). In the case of an absorbent material 49, the water residues 44 are absorbed or wiped away by it (FIG. 26).

The water residues 44 are sucked up by the water suction facility 50 using a negative pressure (FIG. 27). The water residues 44 are vaporized with the aid of the heating element 51 (FIG. 28).

As shown in FIG. 29, it is possible to add the detection and removal of water residues 44 to the existing wash program 27. This can be done in particular during the drying cycle 32 (dashed box).

As shown in FIG. 30, a further application is to detect possible faults and then rectify them. For this purpose, the generally described methodology for detecting objects 21 to 23, 38, 39, including orientation detection, can be used. One example of this is a blocked spray arm. A frequent cause for this can be the user not optimally placing one or more objects 21 to 23, 38, 39 or a movement of the objects 21 to 23, 38, 39 caused by a hydraulic force effect by way of the rinsing process.

The household robot 16 can detect this case by the combination of sensor system 18, in particular in the form of a camera system, and the method for object detection and can release this blockage by correcting the position of the objects 21 to 23, 38, 39. This process for detecting and eliminating the spray arm blockage can be carried out at the beginning or also during the active wash program 27.

Another example is the detection of a clogged sieve system, in particular a coarse sieve and/or a fine sieve, inside the household dishwasher 1. This can be caused, for example, by food residues or other objects. The household robot 16 can detect this case by way of the combination of the sensor system 18 and the method for object detection and by the use of its effector 19, can rectify the fault. This process for detecting and remedying the clogged sieve system can be carried out at the beginning or during the active wash program 27. As FIG. 30 shows, it is possible to detect and eliminate a fault at any point in time during the active wash program 27 (dashed box).

A clear advantage of removing the water residues 44 by the household robot 16 is the possibility of intervening in the wash program 27 even during the wash program 27. For example, it is possible to start the process for removing the water residues 44 immediately after the final rinse cycle 31 in order to achieve a better drying result, as indicated in FIG. 31 by an arrow 52. FIG. 31 shows an exemplary wash program 27 with the newly inserted process section for removing the water residues 44.

FIG. 32 shows an example of a process for detecting and removing water residues 44 in an existing wash program 27. In step S1, a previous wash program step takes place. In step S2, objects 21 to 23, 38, 39 and/or surfaces with water residues 44 are detected. In a step S3, the water residues 44 are removed. Then a check is made to see if further water residues 44 are present. If this is not the case, a subsequent wash program step or a wash cycle end is carried out in a step S4. If water residues 44 are still present, the process returns to step S3 or optionally to step S2.

FIG. 33 shows an abstract representation of an exemplary system 53, independent of the respective methodology. The dashed boxes/lines are optional components or connections that do not necessarily have to be present. The system 53 includes a higher-level control unit 54, a camera system 55 that can be part of the sensor system 18, a camera 56 that can be part of the camera system 55 and a machine learning algorithm 57. In addition, the household dishwasher 1 itself, a manipulator in the form of the robotic arm 17 with the effector 19 and the sensor system 18, as well as one or more receptacles 12 to 14 for items to be washed and objects 21 to 23, 38, 39 are provided.

The household dishwasher 1 thus offers the option of actively intervening in the wash program 27 using the household robot 16. This enables new use cases and/or functions. It is possible to operate the household dishwasher 1 autonomously with the help of the household robot 16 during the active wash program 27. Advantageously, this results in minimal user involvement in the washing process. It is possible to adaptively dispense detergent and rinsing agent. The advantage is that the user's involvement in the washing process is minimal and that the environment and resources are conserved.

It is possible to change the wash program 27 adaptively during the washing process. One advantage of this is that the noise level of the household dishwasher 1 is reduced when people are present. It is possible to optimize the placement of objects 21 to 23, 38, 39 in the household dishwasher 1 or to reposition objects 21 to 23, 38, 39 that have already been placed for optimal cleaning. This advantageously results in improved cleaning performance and/or optimal or maximum loading of the household dishwasher 1.

Improved drying performance is achieved by the targeted removal of possible water residues 44. This advantageously leads to a better drying result and is thus visible to the user. The drying time is reduced because less water is applied to the items to be washed. The advantage of this is a shorter duration of the wash program 27. An autonomous elimination of faults in the household dishwasher 1 is performed with the help of the household robot 16 during the active wash program 27. The advantage of this is that the user's involvement in the washing process is minimized.

Although the present invention has been described with the aid of exemplary embodiments, it is capable of numerous modifications.

### REFERENCE CHARACTERS USED

1 Household dishwasher
2 Dishwasher cavity
3 Door
4 Dishwasher interior
5 Pivot axis
6 Loading opening
7 Base
8 Top
9 Rear wall
10 Side wall
11 Side wall
12 Receptacle for items to be washed
13 Receptacle for items to be washed
14 Receptacle for items to be washed
15 Open-loop and closed-loop control facility
16 Household robot
17 Robotic arm
18 Sensor system
19 Effector
20 Open-loop and closed-loop control facility
21 Object
22 Object
23 Object
24 Bounding Box
25 Bounding Box
26 Bounding Box
27 Wash program
28 Pre-wash cycle
29 Cleaning cycle
30 Intermediate rinse cycle
31 Final rinse cycle
32 Drying cycle
33 Soiling
34 Element
35 Laser facility
36 Compressed air nozzle
37 Water nozzle
38 Object
39 Object
40 Spray jet
41 Spray jet
42 Spray jet
43 Standard pattern
44 Water residue
45 Zone
46 Zone
47 Holder
48 Hinge spike
49 Material
50 Water suction facility
51 Heating element
52 Arrow
53 System
54 Control unit
55 Camera system
56 Camera
57 Machine learning algorithm
A Pull-out direction
E Insertion direction
F Washing liquor and/or fresh water
h Height
S1 Step
S2 Step
S3 Step
S4 Step 5
T Point in time

1-15. (canceled)

16. A household dishwasher, comprising:
a dishwasher cavity for receiving items to be washed;
a household robot; and
an open-loop and closed-loop control facility configured to execute a wash program for cleaning the items to be washed and to interrupt the wash program during execution of the wash program in order to enable the household robot to access the dishwasher cavity.

17. The household dishwasher of claim 16, wherein the household robot comprises a robotic arm with a sensor system and/or an effector.

18. The household dishwasher of claim 17, wherein the sensor system comprises a camera.

19. The household dishwasher of claim 16, wherein the open-loop and closed-loop control facility is configured so as to open a door of the dishwasher cavity in order to enable the household robot to access the dishwasher cavity.

20. The household dishwasher of claim 16, wherein the household robot is positioned inside or outside the dishwasher cavity.

21. The household dishwasher of claim 16, wherein the household robot is configured so as to localize individual objects as the items to be washed.

22. The household dishwasher of claim 21, wherein the household robot is configured so as to change a position of the objects.

23. The household dishwasher of claim 21, wherein the household robot is configured so as to classify the objects with respect to their type, with respect to soiling and/or with respect to water residues.

24. The household dishwasher of claim 23, wherein in order to remove the soiling and/or the water residues, the household robot comprises at least one of a mechanical element, a laser facility, a compressed air nozzle, a water nozzle, a water suction facility and a heating element.

25. The household dishwasher of claim 21, wherein the household robot is configured so as to displace and/or to rotate the objects to facilitate a removal of water residues.

26. The household dishwasher of claim 21, further comprising a receptacle for receiving the objects, said household robot being configured so as to displace and/or to raise the receptacle to facilitate a removal of water residues.

27. The household dishwasher of claim 26, wherein the receptacle is divided into multiple zones, wherein the zones differ from one another by virtue of the fact that different zones are designed for receiving objects that have a different potential for water residues.

28. The household dishwasher of claim 21, wherein the household robot is configured to enable placement of additional objects into the dishwasher cavity after the open-loop and closed-loop control facility has interrupted the wash program.

29. The household dishwasher of claim 28, wherein the open-loop and closed-loop control facility is configured so as to adapt the wash program in dependence upon the objects that have been added.

30. The household dishwasher of claim 16, wherein the household robot is configured so as to detect and eliminate a fault occurring within the dishwasher cavity.

31. The household dishwasher of claim 16, wherein the open-loop and closed-loop control facility is configured so as to adapt the wash program to a presence of people in a vicinity of the household dishwasher.
